(19) United States
(12) Patent Application Publication
(10) Pub. No.: US 2011/0078000 A1
(43) Pub. Date: Mar. 31, 2011

(54) CONTROLLING CONTENT DISTRIBUTION

(75) Inventors: Sheng Ma, Yonkers, NY (US); Fan Zhang, Fair Lawn, NJ (US)

(73) Assignee: GOOGLE INC., Mountain View, CA (US)

(21) Appl. No.: 12/889,917

(22) Filed: Sep. 24, 2010

Related U.S. Application Data
(60) Provisional application No. 61/245,832, filed on Sep. 25, 2009.

(51) Int. Cl. G06F 17/30; G06Q 30/00

(52) U.S. Cl. 705/10; 705/14.41

(57) ABSTRACT

Distributing content using one or more content distributors associated with respective content distribution channels is based on an analysis of historical content distribution information and analysis rules. Recommended actions are provided to a content provider along with estimations of predicted results.

### RELATED APPLICATION

This application claims priority to U.S. Provisional Application Ser. No. 61/245,832, filed Sep. 25, 2009, and entitled “Controlling Content Distribution,” which application is incorporated herein by reference.

### TECHNICAL FIELD

This disclosure relates to controlling content distribution within and across content distribution channels.

### BACKGROUND

Media content may be distributed to provide many types of communication, such as news, entertainment, business, or other communication. Advertisements, for example, may be distributed to communicate information relating to goods and/or services of an associated advertising entity, or to communicate other information to an audience. One form of media content includes electronic advertisements, such as those distributed on the Internet or other communication networks. For electronic advertisements and other forms of media content, advertising entities or other suppliers of media content may desire to deliver media content across one or more selected content distribution channels, including print, radio, television, on-line search engine, on-line display, or email channels, in order to achieve, with a limited budget or other constraints, a suitable return on investment or other performance metrics. Such media content suppliers are able to control distribution of content by selectively setting and/or adjusting one or more distribution parameters. Frequently, different distribution channels involve different distribution parameters. For example, some distribution channels may be competitive, and the content of a highest bidder may be selected for distribution such that bid price is an adjustable parameter controlled by the content suppliers. Other channels may be reservation based, and the content will be distributed at a fixed cost per delivery until an adjustable budget is reached in a fixed period of time. Accordingly, the paid search channel allows an advertiser to choose the keywords, bids for the keywords, and a daily budget, among other parameters, to control the distribution of advertisements. The display channel allows an advertiser to choose publishers to which the advertisements are to be delivered, the total number of impressions per day and/or per campaign, budgets for one or more publishers, and campaign duration, among other parameters. Thus, from an advertiser's perspective, it is important to decide how to allocate budget among different distribution channels, and within a channel, as well as to decide how to tune the distribution parameters of the selected channels so as to optimize the advertisement campaign goals.

### SUMMARY

In one general implementation, distributing content includes receiving, in a content manager, content distribution information regarding how content is to be distributed, automatically analyzing historical data stored in a storage device accessible by the content manager, adjusting the content distribution information based on the analysis of the historical data, and distributing content based on the adjusted content distribution information. Analyzing the historical data includes, normalizing the historical data to obtain a performance metric, categorizing the performance metric to obtain metric driver value, transforming the metric driver value to a recommended action regarding a content distribution setting, and estimating a predicted result of accepting the recommended action.

Implementations may include one or more of the following features. For example, the content distribution information can include information regarding a content distribution channel and content distribution control settings for a content distribution system associated with the content distribution channel, and adjusting the information can include adjusting at least one content distribution control setting for the content distribution system. Distributing content can also include generating recommendation information regarding a recommended adjustment of the content distribution information based on the analysis of the historical data. Adjusting the content distribution information can include adjusting the content distribution information based on the recommended adjustment. Distributing content can also include providing the recommendation information to a user and receiving approved adjustment information from the user, and adjusting the content distribution information can include adjusting the content distribution information based on the approved adjustment information. The recommendation information can include information regarding adjustment of a content distribution setting associated with a content distribution system. The recommendation information can include information regarding adjustment of a content distribution channel. Distributing content can also include receiving rule authoring information from a user and creating a custom rule according to the rule authoring information, and analyzing the historical data can include analyzing the historical data based on the custom rule. Creating the custom rule can include adjusting a default rule. Adjusting the content distribution information can include modifying at least one of content bid information and content budget information based on the recommended setting. Analyzing the historical data can also include converting a current content distribution setting to a recommended content distribution setting based on the recommended action, and estimating a predicted result can include estimating a performance metric predicted to result from distributing content based on the recommended setting.

In another general aspect advertising includes receiving, in an advertisement distribution manager, advertisement information comprising advertisement channel information and channel setting information, analyzing, by the advertisement distribution manager, historical advertisement information based on rules selected from a rule repository, the rules being selected from among default rules and customized rules, the rules being selected based on the advertisement channel information, and automatically outputting, by the advertisement distribution manager, recommendation information regarding a recommended channel setting. Analyzing the historical advertisement information includes normalizing the historical advertisement information to obtain a performance metric, transforming the performance metric to recommendation information regarding a recommended channel setting, and estimating a predicted result of accepting the recommendation information.

In another general aspect, managing advertisement distribution includes storing advertisement distribution rule information on a storage device to create an advertisement distribution rule library, each rule being associated with at least one advertisement distribution channel, receiving advertisement distribution information regarding distribution of at least one advertisement, the distribution information being associated with a user and comprising information regarding at least one distribution channel, analyzing advertisement distribution history data using rules selected from the advertisement rule library based on the advertisement distribution information, and providing, to the user, adjustment information based on the analysis, the adjustment information comprising a recommended distribution setting of a distribution system associated with the advertisement distribution information.

Implementations may include one or more of the following features. For example, analyzing the advertisement distribution history data can include analyzing advertisement distribution history data for at least one advertisement associated with the user. Analyzing the advertisement distribution history data can also include analyzing advertisement distribution history data for an advertisement distribution channel. Managing advertisement distribution can also include creating a custom rule associated with a user, and including advertisement distribution rule information associated with the custom rule in the rule library, and analyzing advertisement distribution history data uses the custom rule.

In another general aspect, a content distribution management system includes an analysis rule library repository including rules regarding analysis of content distribution information, a user data repository, and a content distribution analyzer computer processor. The content distribution analyzer computer processor includes an analysis pipeline configured to analyze content distribution history data according to selected rules of the rule library repository. The selected rules are selected based on information of the user data repository. Analysis of the content distribution historical data includes normalizing the historical data to obtain a performance metric, transforming the performance metric to a recommended action regarding a content distribution setting, estimating a predicted result of accepting the recommended action, and outputting the recommended action

Implementations may include one or more of the following features. For example, the content distribution management system can also include a rule authoring module operable to create a rule in the rule library for use in analyzing content distribution history data. The analysis pipeline of the content distribution analyzer computer processor is further configured to modify at leas one of content bid information and content budget information based on the recommended setting. The content distribution management can also include a converter module configured to change a current content distribution setting to a recommended content distribution setting based on the recommended action, and the estimator can be configured to estimate a performance metric predicted to result from distributing content based on the recommended setting.

The details of one or more implementations are set forth in the accompanying drawings and the description below. Other features will be apparent from the description and drawings, and from the claims.

### DESCRIPTION OF DRAWINGS

FIG. 1 is an illustration of a system for controlling distribution of media content.

FIG. 2 is a diagram illustrating a content distribution manager.

FIG. 3 is a diagram illustrating a computer system operable in the system of FIG. 1.

FIGS. 4 and 5 are flow charts illustrating processes for controlling content delivery.

Like reference symbols in the various drawings indicate like elements.

### DETAILED DESCRIPTION

In many situations, a content provider, such as an advertiser, may wish to distribute content in such a way as to achieve a desired result, such as reaching a large audience for great dissemination of content. Some content providers, including advertisers, may want to improve one or more performance metrics, such as a return on investment on their advertising budget. In some instances, performance metrics relevant to a content provider include media cost per impression or media cost per action by a viewer of the content, including cost per click or cost per conversion. In an attempt to achieve a selected goal, such as achieving a lowest possible cost per click, or a selected combination of goals, a content provider can set or adjust one or more parameters of a content distributor associated with the content distribution channel. For example, in an on-line search advertising distribution channel, the content distributor can be the paid search advertisement platform, such as the ADWORDS system operated by Google, Inc., that selects advertisements for display to users based on searched keywords and keyword bids submitted by content providers. Accordingly, the content provider can adjust their bids for each keyword, including adding or removing keywords, in an effort to find the most cost effective keywords and reduce a cost per click associated with an advertisement campaign.

Often the number of controllable parameters that an advertiser can adjust for each advertisement campaign can make it difficult to effectively and efficiently control the distribution, or improve performance of the advertisement campaign. For example, in a paid search channel, an advertisement campaign can use thousands of keywords, or even tens of thousands of keywords. This results in thousands of parameters that may need to be adjusted in order to achieve optimal results. Further, such adjustment should be performed in an on-going basis so as to keep up with a dynamic and competitive market.

In addition, especially where the selected goal of the content provider involves a performance metric that is affected by multiple parameters, achieving the goal can be difficult. In some distribution channels, there can be multiple parameters that affect a given performance metric, and each parameter can have multiple setting values. Thus, a content provider must choose from thousands of parameter setting combinations when attempting to optimize the settings to achieve or approach the goal. For example, if a content provider selects to obtain a maximum amount of revenue from their total media budget, the content provider may need to adjust different parameters to increase a total number of impressions of their advertisements, while also reducing a cost per impression, and/or increasing a click through rate. Adjusting some content distribution parameters can impact different performance metrics differently. For example, bidding higher on a keyword will likely increase a number of impressions of an advertisement, but will also increase a total cost for the advertisement. It can be difficult to predict whether and how much to adjust various parameters in order to strike an optimum balance between desired results and cost. This difficulty can be compounded by inexperience if the content provider is not an expert in using the distribution channel and is not familiar with the affect of such settings or adjustments.

Thus, it is very time consuming and complex for an individual to adjust such a large set of parameters manually in a timely manor. In many situations, a content provider can benefit from at least partial automation of setting and or adjustment of distribution parameters. For example, these difficulties can be overcome by a content distribution manager system that analyzes performance data regarding historical content distribution information, obtains performance metrics from the historical data, provides an indication of a relative quality of the achieved performance metrics, recommends adjustments to relevant distribution parameters based on a selected goal or combination of goals, and estimates the anticipated performance metrics that may be obtained if content is distributed with the recommended content distribution parameter settings.

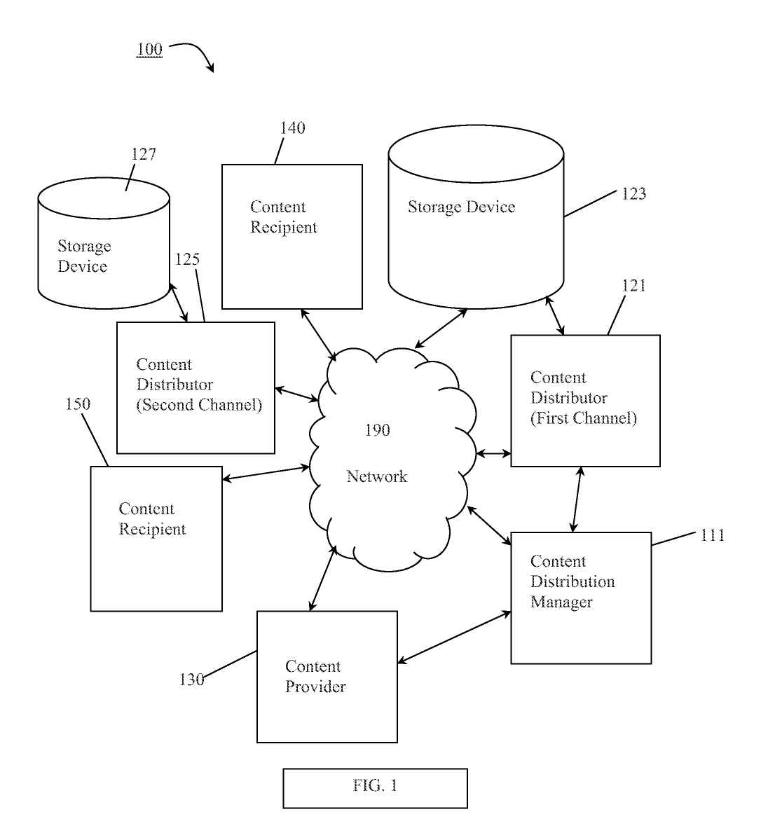

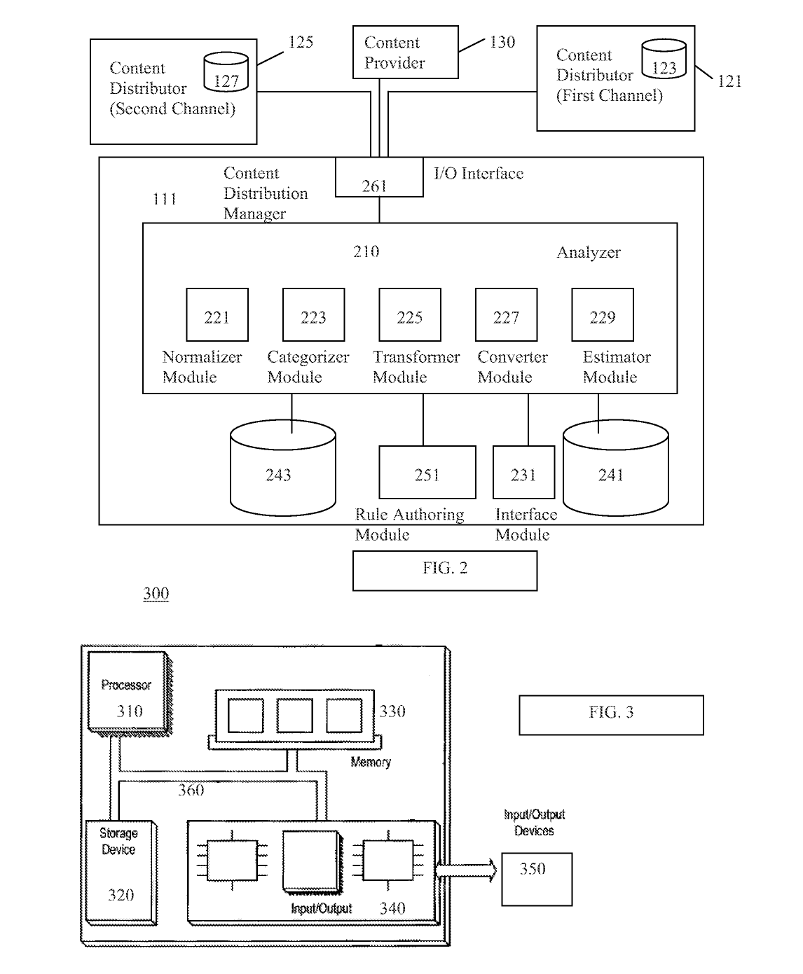

Referring to FIG. 1, a system 100 for distributing content, including advertisements includes, for example, a content distribution manager 111, a content provider 130, content recipients 140 and 150, content distributors 121 and 125, and storage devices 123 and 127 storing historical data, which may be directly connected to one or more other component of the system 100, and/or which may be connected by a network 190, such as the Internet. The content distributors 121 and 125 enable the distribution of content, including advertisements, provided by the content provider 130, such as an advertiser, to the content recipients 140 and 150, which may be individuals using the Internet, including the World Wide Web. For example, the content distributors can include content distribution platforms such as the AdWords system operated by Google, Inc, and the Dart system operated by DoubleClick, Inc., among others. The content distribution manager 111 is operable to provide recommendations regarding control of the content distributors 121 and 125 to control, within the framework of the content distributors 121 and 125, how content is distributed to the content recipients. Each of the content distribution manager 111, the content provider 130, the content recipients 140 and 150, the content distributors 121 and 125, and the storage devices 123 and 127 may be configured as a computer, a system of computers, or a component of a computer system. For example, a computer 300, illustrated in FIG. 3, includes a processor 310, memory modules 330, a storage device 320, and input-output modules 340 connected by a system bus 360. The input-output modules 340 are operable with one or more input and/or output devices 350, including a communication device for operable connection with the network 190 and with the other components of the system 100.

In some implementations, the content distributors 121 and 125 are associated with respective content distribution channels. For example, in an Internet advertising implementation, the content distributors 121 and 125 are associated with a paid search advertisement distribution channel and a display advertisement distribution channel, respectively. Each of the content distributors 121 and 125 is configured to distribute advertisements provided by advertisers, such as the content provider 130, to content recipients 140 and 150, such as Internet browser programs executed on computer systems. When the content recipients 140 and 150 request content, such as search results and/or web pages, the content distributors 121 and 125 distribute advertisements to the content recipients 140 and 150 based on respective content distribution settings. For example, the content distributor 121 can distribute advertisements based on search query keywords of a search requested by one or more of the content recipients 140 and 150 and based on keyword bids placed by content providers, including the content provider 130. Similarly, the content distributor 125 can distribute advertisements based on reservations of advertisement slots made by content providers, including the content provider 130.

Information regarding bids and reservations, among other information, is stored on the storage devices 123 and 127 for access by the content distributors 121 and 125. In many implementations, the content distributors 121 and 125 will distribute content based on many parameters, at least some of which can be set and/or adjusted by the content provider 130. Additionally, information regarding these parameters can also be stored on the storage devices 123 and 127, and/or information regarding content recipients and/or historical information regarding past content distribution activity of the content distributors 121 and 125 can be stored on the storage devices 123 and 127. As will be understood, any other information which is relevant to content distribution in the respective distribution channels can be stored on the storage devices 123 and 127, or on other similar storage devices operable with the content distributors 121 and 125. In order to enable the content provider 130 to set and/or adjust selected parameter settings of the content distributors 121 and 125, each of the content distributors 121 and 125 includes an interface accessible by the content provider 130.

The content distribution manager 111 is operable at least with the content provider 130 to facilitate control of the distribution of the content associated with the content provider 130 through one or more of the content distributors 121 and 125. For example, in some implementations, the content distribution manager 111 is configured to receive content distribution information from the content distributors 121 and/or 125, the storage devices 123 and/or 127, and/or from the content provider 130. Additionally, the content distribution manager 111 is configured to analyze the content distribution information, to provide recommendations regarding distribution parameter settings and/or adjustments thereto, and to estimate a predicted result of distributing content using such recommended settings and/or adjustments. In some implementations, the content distribution manager 111 is configured to receive information regarding review, acceptance, and/or modification of the recommended settings and/or adjustments to the distribution parameters, and to transmit parameter setting and/or adjustment information to one or more of the content distributors 121 and 125.

For example, the content distribution manager 111 receives raw historical data regarding delivered impressions of an advertisement, such as total impressions, total clicks, media cost, total actions, total actions by advertisement. Based on the received data, the content distribution manager 111 calculates selected performance metrics, such as cost per impression, cost per click, cost per conversion, and click through rate for the advertisement. The content distribution manager can determine that a bid for a first keyword associated with the advertisement should be increased, and/or that a bid for a second keyword should be decreased in order to reduce the cost per click associated with the advertisement. The specific amounts of bid increase and decrease can be selected such that an anticipated media cost for distribution of the advertisement using the recommended bid amounts will not exceed a predetermined budget. The recommended bid amounts and/or bid adjustments can be provided to the content provider 130 for review, acceptance, rejection, and or modification. After receiving input from the content provider 130, the content distribution manager can output the recommended distribution parameter settings for use in distributing content. In some implementations, the content distribution manager 111 can directly set or adjust the distribution parameter settings of the content distributors 121 and 125 according to the accepted or revised parameter settings.

Referring to FIG. 2, the content distribution manager 111 can include a rule library stored on a storage device 243. The rule library contains, for example, advertisement distribution rule information, analysis rule information, and/or estimation rule information. Each rule in the library is associated with at least one of the content distributors 121 and 125, and/or at least one content provider, such as the content provider 130. The content distribution manager 111 also includes a data structure stored on a storage device 241 that includes information regarding the content provider 130, computer executable instructions or computer software, and other data. The content distribution manager 111 also includes an analyzer 210 comprising an analysis pipeline having analysis modules 221-231, a rule-authoring module 251, and an input/output interface 261.

The analyzer 210 is configured to analyze the content distribution information received over the network 190 through the input/output interface 261 from, for example, storage devices 123 and 127 of the content distributors 121 and 125. The analyzer 210 is configured to analyze the content distribution information according to one or more selected rules of the rule library in conjunction with operating software stored on the storage device 241. The rules can include default rules or rule sets and/or custom rules or rule sets in the rule library created using the rule-authoring module 251 by the content provider 130, or by another user, such as an operator of the content distribution manager 111. The analyzer 210 includes a normalizer module 221 that is configured to derive at least one performance metric based on received content distribution information. The analyzer 210 also includes a categorizer module 223 configured to obtain driver values based on the content distribution information and/or derived performance metrics, a transformer module 225 configured to obtain a recommended action regarding a content distribution setting based, at least in part, on driver values, and a converter module 227 configured to derive a recommended content distribution setting based, at least in part, on a current content distribution setting and on a recommended action. The analyzer 210 also includes an estimator module 229 configured to forecast a result of accepting the recommended action and/or to estimate expected content distribution data predicted to result from distributing content using the recommended content distribution settings. The content distribution manager 111 can also include one or more additional modules, such as an interface module 231 configured to provide additional functionality, such as to receive inputs from the content provider 130, or other user, regarding acceptance, rejection, or alteration of a recommended content distribution setting, and/or to implement accepted recommendations in a content distributor.

In use, and as illustrated in FIG. 4, a process 400 includes receiving, by the content distribution manager 111, information regarding content distribution (401). The content distribution information is associated with the content provider 130 and includes information regarding at least one content item, such as an advertisement, and at least one content distribution channel. For example, the content distribution information can include information identifying a particular advertisement associated with a particular advertiser which is to be distributed through a particular channel. The distribution information can further include information regarding content distribution control settings and/or channel setting information. For example, the content distribution information can include advertising campaign information, such as a total budget, a channel budget, a budget fraction, a campaign duration, a priority indication, a bid price, a minimum position, or other general information regarding the advertisement and/or the advertiser's goals or plans. The specific type of content distribution information that is included will often depend on the type of advertisement and/or the type of distribution channel. For example, a search advertisement can include keyword bid information regarding a maximum price or price component to be paid for selecting the advertisement for display in response to a search including the keyword and a minimum display rank regarding acceptable positions in a list of advertisements, whereas a display advertisement can include scheduling information indicating how many times and how often the advertisement is to be displayed, size information, position information regarding a position on a display, and location information regarding a web page on which the advertisement is to be displayed. In addition, the content distribution information can include targeting information for use in selecting content recipients to receive the content.

In cases where the content has previously been distributed through the channel, the content distribution information also includes historical data associated with such distribution. For example, if the content is an advertisement, and the channel is the paid search advertisement channel 121, the content distribution information includes raw data regarding each instance where an advertisement was delivered by the paid search advertisement channel 121 in response to an advertisement request. The requests can be based on search queries that include a keyword for which the content provider 130 placed a bid for the advertisement. In this example, the content distribution data includes a rank assigned to the advertisement for each time the advertisement was considered, an indication of whether the advertisement was delivered, an indication of the rank of the slot for each instance that the advertisement was selected and/or delivered, an indication of whether the advertisement was viewed, selected or activated by a content viewer, and an indication of whether a subsequent action, such as a purchase, occurred as a result of viewing, selecting or activating the advertisement. Other data can also be collected regarding distribution of the content.

Where a display advertisement channel is involved, the content distribution information can include data such as a number of times that an impression of the advertisement was delivered, an indication of the locations to which impressions of the advertisement were delivered, a number of times that the impression of the advertisement was viewed, selected, and/or activated by a content viewer, and/or a number of times that the subsequent action was taken. The data can also include per event cost data and summary cost data, including total media cost for the advertisement. In some implementations, the content distribution information includes all data available from a content provider 130 and/or one or more of the content distributors 121 and 125. In other implementations, the content distribution information includes less than all of the available data from the content provider 130 and/or one or more of the content distributors 121 and 125, such as only the distribution information from a previous day, week, or month.

After receiving the content distribution information transmitted by the content provider 130, the content distributor 121, and/or the content distributor 125, the content distribution manager 111 automatically analyzes the content distribution information (403), which is stored on the storage device 241. In some implementations, the content distribution information can be stored on one or more of the storage devices 123 and 127, and the content distribution manager 111 can receive the content distribution information by accessing the storage devices containing the information. The analysis of the content distribution information is performed according to one or more rules or rule sets selected from the rule library based on the received content distribution information.

For example, information identifying the content provider 130 may be sufficient to allow the content distribution manager 111 to select a rule or rule set associated with the content provider 130. In some implementations, the content provider may have different rules or rule sets defined for different advertisements, advertisement campaigns, advertisement channels, and/or time periods, and the content distribution manager 111 selects the appropriate rule or rule set based on these parameters, or any other desired criteria. Such rules, or rule sets, can be associated with different settings of the content distribution manager 111, which may be associated with different goals or goal sets of the content provider 130. As an example, the content distribution manager 111 can include a single setting, such as a “maximize return on investment” setting, that is configured to cause the content distribution manager to utilize a predefined (including where defined by the content provider 130) rule or rule set that is designed to maximize or increase a return on investment for a media budget. Other settings can also be included, such as a “maximize impressions” setting, a “maximize clicks” setting, a “maximize click-through rate” setting, a “minimize cost per click” setting, or another setting selected by the content provider 130. Such settings can be used for the entire account of the content provider, a single campaign, or a particular advertisement. Alternatively, no global settings can be used, and specific rules or rule sets can be defined for each analysis action.

When such a goal of optimization is selected, the content distribution manager can automatically analyze the historical information, automatically provide recommended actions and/or distribution channel settings, and/or implement the recommended actions. The automatic actions are performed according to selected rules or rule sets. The rules and/or rule sets can include default rules available to all content providers for an associated content distribution channel, or customized rules specifically associated with the content provider 130, and the rule sets can also be default rule sets or customized rule sets. Such customized rules or rule sets are authored by content providers, or other users of the content distribution manager 111, using the rule-authoring module 251. In some implementations, the content provider can create customized rules or rule sets by adjusting default rules or rule sets and/or by creating new rules and rule sets which are not based on any default rule. The customized rules and rule sets for the content provider 130 are stored in the storage device 243.

For example, where the content provider 130 has a domain knowledge regarding a particular product, industry, distribution channel, or targeted recipient or group of recipients, the content provider 130 can create customized rules and/or rule sets to encode such domain knowledge such that the content distribution manager 111 operates according to the best practices of the content provider. Additionally, the content provider 130 may simply have different goals, or may favor a different balance between goals from those achieved by the default rules and/or rule sets. Thus, depending on a selected goal or goal set, including selected rules or rule sets, the content distribution manager 111 can operate differently for different distribution channels, industries, or content providers to provide desired analysis of the content distribution information. The content distribution manager 111 also can operate using different rules or rule sets depending on the content for which analysis and recommendation are performed.

Additionally, a rule refining module can be included which is operable to adjust default or user-specific rules based on automatic analysis of available data. For example, where historical information indicates that modifying a rule like the default or user-specific rule in a particular way improves results in one or more performance metric with little or no cost, the rule refining module can automatically modify the default or user-specific rule in the particular way. For example, the rule refining module can include learning algorithm, such as linear regressions or logistic regressions, among others. Thus, the content distribution manager 111 can dynamically create and modify rules to assist users achieve or approach their selected goals.

Following completion of the analysis (403), the content distribution manager 111 automatically outputs recommendations and estimations to the content provider 130 regarding one or more content distribution settings based on the analysis (405). For example, the recommendations may include a recommended adjustment of a paid search advertisement bid value for a keyword, a recommended adjustment of a budget value for a search advertisement or a display advertisement, a recommended adjustment of a budget for a campaign, or a recommended adjustment of a budget for a distribution channel. The output format can include an indication of a change to be applied to a current value for a current parameter, an indication of a new value for a current parameter, or an indication of a new value for a recommended new parameter. In the context of a search advertisement, the recommendations can include a recommended change to a keyword bid value that is currently being used to distribute the advertisement, a new bid value (e.g., the recommended change taking into account the old bid value) for the keyword, and/or a new recommended bid amount for a keyword not currently being bid on by the content provider 130. As discussed above, by use of the rules or rule sets, the content distribution manager outputs recommendations that are determined to achieve or approach a selected goal or goal set for the distribution of the content. Thus, distribution of the content using the output recommendations should result in derived performance metrics derived from future historical information which are closer to desired values than the currently derived values of the performance metrics.

The content distribution manager 111 also automatically outputs estimations that relate to predicted results of accepting the recommendations (i.e., making an adjustment according to the recommendations), which should reflect in advance the expected improvements associated with the recommendations. The estimations can include expected content distribution data, such as expected clicks, expected impressions, expected rank, expected media cost, expected sales, expected revenue, or expected values for any other data collected by the content provider 130 and/or the content distributor 121 or 123 associated with the content. Thus, the content provider can understand what effect the recommended action (whether a change or not from current settings) will have on relevant performance metrics for distribution of the content. As discussed in greater detail below, the recommendations and/or the estimations are generated by the analyzer 210 based on rules or rule sets stored in the storage device 243, such as those associated with a selected goal or goal set, and are intended to provide desired results if accepted. However, the content provider 130 is able to accept or reject (including by modification) the recommended actions associated with the recommendations.

Then, based on the accepted or modified recommendation information, the content distribution manager 111 performs appropriate adjustments of the content distribution settings of the content distributor (407). The adjustments can include directly adjusting distribution settings of one or more content distributors 121 and 125 through an interface with the content distribution manager 111. The content is then distributed based on the adjusted content distribution settings (409) and content distribution data is collected (411) based on such distribution. The content distribution data resulting from the distribution of step 409 can be collected in preparation for a subsequent analysis (403), enabling an iterative content distribution control process. As will be understood, repeated iterations of the analysis, recommendation, and implementation functions of the content manager 111 can quickly approach an optimum performance level for the content distribution relative to the selected goal or goal set. However, as the content provider 130 revises the goal or goal set, the content distribution manager 111 will automatically recommend or adjust the settings of the content distributors 121 and 125 to achieve or approach the revised goal or goal set. Additionally, the content distribution manager 111 can automatically recommend or adjust the settings of the content distributors 121 and 125 in order to continue to achieve or approach a goal or goal set in response to changing circumstances, such as the entry of additional or different competitors, a reduction in content distribution by the content distributors 121 an/or 125, or other changes in the content distribution environment by repeated and/or periodic analysis of the historical information, and generation of recommended actions.

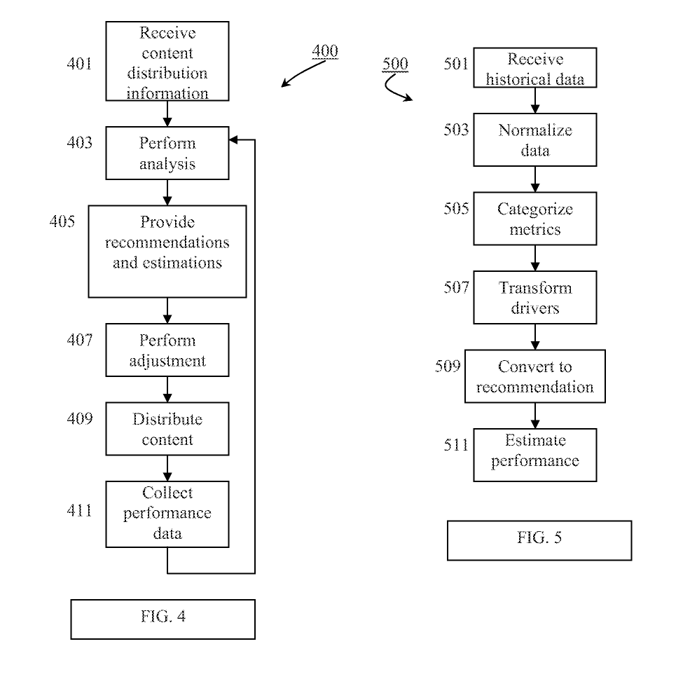

In some implementations, the content distribution manager 111 can execute process 500, illustrated in FIG. 5, which includes receiving historical content distribution data (501). The historical content distribution data includes raw data collected by the content distributor 121, for example. For each campaign, such as a group of keywords for a paid search advertisement or a group of advertisement slots for a display ad, the content distribution manager 111 normalizes the historical content distribution data for each component of the campaign to obtain performance metrics for the campaign and campaign components over a selected period of time. For example, the normalizer module 221 processes the raw historical content distribution data to derive selected performance metrics according to rules stored on the storage device 243 (503).

In the paid search advertisement example discussed above, the normalizer module 221 derives a cost per click by dividing a number of times that content recipients 140 and 150 activated the advertisement by the total media cost for the advertisement over the time in which the clicks were received. In some implementations, the analysis of the raw historical content distribution data is performed once per day, and/or on-demand, although other periodic intervals can be used. A click-through rate, a return on investment, a cost per action, average position, and/or other performance metrics are similarly derived according to rules associated with the piece of content. The derived performance metrics and/or selected pieces of raw data, such as a number of clicks, prior bid amount, prior minimum position, a number of sales, a value of the sales, and/or other data are provided to the content provider 130 for review.

Additionally or alternatively, the normalizer module 221 can derive other performance metrics based on default or customized rules. In some implementations, one or more of the performance metrics can be based, at least in part, on activity of the content distributor 121 that does not involve the advertisement. For example, a market share metric can be derived by dividing a total number of impressions of the advertisement divided by a total number of searches that were requested by all users that included a keyword for which the content provider 130 has placed a bid for the advertisement. Thus, the analysis can provide the content provider with a reference point for the performance of the advertisement relative to other similar and/or competing advertisements. As should be understood, raw values of such channel-wide parameters can also be displayed without derivation, as can selected values specific to the performance of the advertisement. Similarly, channel-wide values for cost per click, click-through rate, or other performance metrics can be derived and provided to the content provider for review.

The resulting performance metrics and/or data values for each component of the campaign are categorized (505) by the categorizer module 223 to obtain metric driver values according to selected rules and the metric driver values are provided to the content provider 130 for review. In some implementations, the metric driver values can be qualitative, e.g., text descriptors selected from a group, e.g., excellent, good, average, poor, and terrible, of the driver values can be quantitative, e.g., positive or negative integer values selected from a predetermined range, e.g., −5 to +5. The metric driver values indicate an extent to which the campaign component drives, or affects, the data value or performance metric, and its relative performance compared to other components of the campaign. For example, a click driver value, which indicates a relationship between a keyword and the number of clicks obtained from the advertisement, can be obtained by the categorizer module 223 based on the average number of clicks for all keywords. For example, if the number of clicks associated with a keyword is 50% higher than the average, it may be considered excellent in terms of driving clicks. Thus, the click driver value associated with the keyword can be “excellent” or “5” on a scale from 1 to 5. Here, the categorizer uses a threshold rule extracted from domain practices, which indicates that 50% is an appropriate threshold for a value of excellent. The value of excellent indicates that the budget spent on the keyword is highly effective at generating clicks on the advertisement, and is better than other keywords in consideration which have lower click driver values. The average position, the click-through rate, and the number of clicks, among others, can also affect the click driver value, or other metric driver values. Similarly, other drivers are obtained, such as a growth driver that indicates whether spending additional budget for the campaign component will yield a greater number of impressions. Also, the drivers can be obtained on channel-wide data, such as by a rule that categorizes cost per click based on a number of standard deviations from an average cost per click for the channel (or industry or content provider). It is important to note that nearly any performance metric and/or driver value can be derived and obtained by the normalizer module 221 and the categorizer module 223 by authoring an appropriate rule.

Particularly for inexperienced content providers, the driver values may frequently be more helpful than the actual metric values. For example, an inexperienced advertiser (even if experienced in other forms of advertising, but new to a particular channel) may not be adequately familiar with the channel or industry to learn anything of value from an indication that a cost per click associated with a keyword is fifteen cents. Thus, a default rule that provides the advertiser with a driver value for clicks that can be compared to a scale can be more helpful.

The transformer module 225 transforms the driver values into recommended action levels regarding content distribution settings (507). The recommended action levels are designed to reflect a desired action based on an associated driver value, such that an advertisers best practices are automatically implemented based on the analysis of the historical data, which allows the advertisers budget to be spent more effectively, increasing performance by increasing budget allocation to productive campaign components and decreasing budget allocation to unproductive campaign components. Transforming the drivers involves, for example, obtaining a recommended action, such as “bid up by 2 levels,” from a set of rules. The recommended action levels can be independent, such as increase (or reduce) bid or budget by a predetermined amount, or by a predetermined percentage of a current amount. The recommended action levels can also be dependent on another value, such as where a bid is increased by ten percent of the channel-wide average bid, or to five percent greater than the average bid value associated with a rank one position closer to a desired rank than the current average rank of the advertisement.

In some implementations, the analyzer 210 can associate the recommended action levels with portions of the driver value range, such that if a driver value falls within a first exclusive range, a first recommended action level is provided, and if the driver value falls in a second exclusive range, a second different action level is provided. However, other rule formats can be employed to obtain the recommended action levels for content distribution settings based on one or more driver values. Referring back the to the previous example, the combination of an “excellent” cost per click driver, an “excellent” growth driver, and an “excellent” click-through rate driver can result in a recommended action level to bid up on the associated campaign component.

Current content distribution settings are then converted by the converter module 227 to recommended content distribution settings (509). The conversion from a current content distribution setting to a recommended content distribution setting is performed according to one or more rule based on one or more recommended action levels. A recommended content distribution setting is, for example, a recommended bid amount for a given keyword in a given advertising channel. Two or more recommended action levels may be obtained for the same content distribution setting, and the rules can be configured to account for contradictory or confirmatory recommended action levels for the same content distribution setting. For example, the recommended action levels for a content distribution setting for a campaign component can be summed to obtain a net recommended action level, which can be applied to the current setting to obtain the recommended content distribution setting. The recommended content distribution settings are provided to the content provider for review.

Additionally, predicted values for selected parameters and performance metrics are estimated by the estimator module 229, and the estimated value predictions are provided to the content provider 130 (511). The estimator module 229 estimates a predicted result of accepting the recommended actions levels and/or the recommended distribution settings such that the content provider can understand what the current rules and rule sets will, when implemented without adjustment or revision, obtain as a result. For example, the estimator module 229 could predict that modifying a current bid level in an advertisement channel to a recommended bid level would result in an increase in the number of advertisement impressions delivered by the content distributor 121 to the recipients 140 and 150 through the affected distribution channel. A corresponding increase in media cost for the keyword can also be estimated and provided to the content provider 130.

Additionally, the process 500 can include other tiers of recommendation and estimation. For example, the converter module 227 can convert the current content distribution settings to recommended content distribution settings based on recommended action levels for multiple campaign components, including campaign components from different campaigns, and/or based on content distribution settings for one or more campaigns and/or across campaigns. In a simple example, the recommended action levels for a keyword of a paid search advertisement can, according to rules associated with the keyword and as described above, be combined to obtain a recommended action level for a bid associated with the keyword. In addition, the converter module 227 can further combine and/or compare such a recommended action level for the bid based on the performance metrics and data of the keyword with performance recommended action levels for bids of different keywords in the campaign, and adjust one or more recommended bid action level(s) in order to ensure that the total effect of all the recommended bid action levels does not result in the new bids exceeding a predetermined campaign budget. Similarly, the converter module 227 can combine and/or compare bid action levels of keywords in different campaigns, and adjust one or more of the recommended bid action levels to achieve a predetermined result, such as a minimum possible cost per click (optionally while receiving at least a minimum number of clicks, or the like). Thus, where two keywords both merit an increased bid according to respective rules or rule sets associated with each, the converter module 227 can, according to another rule or rule set, adjust the recommendation by increasing the bid for one keyword more than an amount associated with the recommended action level because a current or estimated cost per click associated with the first keyword is less than the cost per click of the second keyword.

As will be understood by those skilled in the art, implementations of the disclosed subject matter and the functional operations described in this specification, such as the content distribution manager 111 and its related functions, can be implemented in digital electronic circuitry, or in computer software, firmware, or hardware, including the structures disclosed in this specification, such as the computer 300, and their structural equivalents, or in combinations of one or more of them. Embodiments of the subject matter described in this specification, such as the analyzer 210, can be implemented as one or more computer program products, i.e., one or more modules of computer program instructions encoded on a tangible program carrier for execution by, or to control the operation of, one or more data processing apparatus. The tangible program carrier can be a computer readable medium. The computer readable medium can be a machine-readable storage device, a machine-readable storage substrate, a memory device, or a combination of one or more of them.

The term “data processing apparatus” encompasses all apparatuses, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, a cross-platform runtime environment, or a combination of one or more of them. In addition, the apparatus can employ various different computing model infrastructures, such as web services, distributed computing and grid computing infrastructures.

A computer program (also known as a program, software, software application, script, or code) can be written in any form of programming language, including compiled or interpreted languages, declarative or procedural languages, and the program can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can in various implementations be performed by, and apparatus can in various implementations be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor 310 for performing instructions and one or more memory devices 330 for storing instructions and data. Generally, a computer will also include, or be operatively coupled to receive data from or transfer data to, or both, one or more mass storage devices 320 for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having input-output module 340, operable with one or more input/output devices 350, such as a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

While some implementations are described above, these should not be viewed as exhaustive or limiting, but rather should be viewed as exemplary, and included to provide descriptions of various features. It will be understood that various modifications may be made without departing from the spirit and scope of the invention. For example, while implementations involving advertising content have been described, the distribution of other content, such as songs on a radio distribution channel, can be controlled as described above. Similarly, book distribution, or distribution of any other content can be controlled. In such alternative implementations, various different rules and rule sets, including respective default rules and rule sets will be employed. However, in many or all implementations, the content distribution manager 111 can include some or all of the components and/or functionality described herein.

Furthermore, it should be noted that actions recited in the claims can be performed in a different order and still achieve desirable results. Certain features that are described in this specification in the context of separate embodiments can, in some implementations, be implemented in combination in a single implementation. Conversely, various features that are described in the context of a single embodiment can, in some implementations, be implemented separately, or in any suitable sub-combination.

Similarly, while operations are depicted in the drawings in a particular order, this should not be understood as requiring that such operations be performed in the particular order shown or in sequential order, or that all illustrated operations must be performed, to achieve desirable results. Moreover, the separation of various system components in the embodiments described above should not be understood as requiring such separation in all embodiments.

As an example, while on-line advertising is discussed above, other types of advertisements can be controlled, such as print, television, telephone or other marketing or advertising channels can be included. Similarly, distribution of non-advertising content can be controlled.

Accordingly, other embodiments are within the scope of the following claims.

1. A method for distributing content comprising:
receiving, in a content manager, content distribution information regarding how content is to be distributed;
automatically analyzing historical data stored in a storage device accessible by the content manager, the analyzing comprising:
normalizing the historical data to obtain a performance metric,
categorizing the performance metric to obtain metric driver value,
transforming the metric driver value to a recommended action regarding a content distribution setting, and
estimating a predicted result of accepting the recommended action;
adjusting the content distribution information based on the analysis of the historical data; and
distributing content based on the adjusted content distribution information.

2. The method of claim 1, wherein the content distribution information comprises information regarding a content distribution channel and content distribution control settings for a content distribution system associated with the content distribution channel, and wherein adjusting the information comprises adjusting at least one content distribution control setting for the content distribution system.

3. The method of claim 1, further comprising generating recommendation information regarding a recommended adjustment of the content distribution information based on the analysis of the historical data.

4. The method of claim 3, wherein adjusting the content distribution information comprises adjusting the content distribution information based on the recommended adjustment.

5. The method of claim 3, further comprising providing the recommendation information to a user and receiving approved adjustment information from the user, wherein adjusting the content distribution information comprises adjusting the content distribution information based on the approved adjustment information.

6. The method of claim 3, wherein the recommendation information comprises information regarding adjustment of a content distribution setting associated with a content distribution system.

7. The method of claim 3, wherein the recommendation information comprises information regarding adjustment of a content distribution channel.

8. The method of claim 1, further comprising receiving rule authoring information from a user and creating a custom rule according to the rule authoring information, wherein analyzing the historical data comprises analyzing the historical data based on the custom rule.

9. The method of claim 8, wherein creating the custom rule comprises adjusting a default rule.

10. The method of claim 1, wherein adjusting the content distribution information comprises modifying at least one of content bid information and content budget information based on the recommended setting.

11. The method of claim 10, wherein analyzing the historical data further comprises converting a current content distribution setting to a recommended content distribution setting based on the recommended action, wherein estimating a predicted result comprises estimating a performance metric predicted to result from distributing content based on the recommended setting.

12. A method for advertising comprising:
receiving, in an advertisement distribution manager, advertisement information comprising advertisement channel information and channel setting information;
analyzing, by the advertisement distribution manager, historical advertisement information based on rules selected from a rule repository, the rules being selected from among default rules and customized rules, the rules being selected based on the advertisement channel information, wherein analyzing includes normalizing the historical advertisement information to obtain a performance metric, transforming the performance metric to recommendation information regarding a recommended channel setting, and estimating a predicted result of accepting the recommendation information; and
automatically outputting, by the advertisement distribution manager, the recommendation information regarding a recommended channel setting.

13. A method for managing advertisement distribution comprising:
storing advertisement distribution rule information on a storage device to create an advertisement distribution rule library, each rule being associated with at least one advertisement distribution channel;
receiving advertisement distribution information regarding distribution of at least one advertisement, the distribution information being associated with a user and comprising information regarding at least one distribution channel;
analyzing advertisement distribution history data using rules selected from the advertisement rule library based on the advertisement distribution information; and
providing, to the user, adjustment information based on the analysis, the adjustment information comprising a recommended distribution setting of a distribution system associated with the advertisement distribution information.

14. The method of claim 13, wherein analyzing the advertisement distribution history data comprises analyzing advertisement distribution history data for at least one advertisement associated with the user.

15. The method of claim 14, wherein analyzing the advertisement distribution history data further comprises analyzing advertisement distribution history data for an advertisement distribution channel.

16. The method of claim 14, further comprising creating a custom rule associated with a user, and including advertisement distribution rule information associated with the custom rule in the rule library, wherein analyzing advertisement distribution history data uses the custom rule.

17. A content distribution management system comprising:
an analysis rule library repository including rules regarding analysis of content distribution information;
a user data repository; and
a content distribution analyzer computer processor comprising:
an analysis pipeline configured to analyze content distribution history data according to selected rules of the rule library repository, the selected rules being selected based on information of the user data repository, wherein the analysis of the content distribution history data includes normalizing the historical data to obtain a performance metric, transforming the performance metric to a recommended action regarding a content distribution setting, estimating a predicted result of accepting the recommended action, and outputting the recommended action.

18. The content distribution management system of claim 17, further comprising a rule authoring computer processor operable to create a rule in the rule library for use in analyzing content distribution history data.

19. The content distribution management system of claim 17, wherein the analysis pipeline of the content distribution analyzer computer processor is further configured to modify at least one of content bid information and content budget information based on the recommended setting.

20. The content distribution management system of claim 19, wherein the analysis pipeline of the content distribution analyzer computer processor is further configured to change a current content distribution setting to a recommended content distribution setting based on the recommended action, and to estimate a performance metric predicted to result from distributing content based on the recommended setting.
